(19) United States
(12) Patent Application Publication
(10) Pub. No.: US 2016/0183479 A1
(43) Pub. Date: Jun. 30, 2016

(54) VEGETATION PROTECTION SYSTEMS

(71) Applicant: Jeremy S. Harold, West Roxbury, MA (US)

(72) Inventor: Jeremy S. Harold, West Roxbury, MA (US)

(21) Appl. No.: 14/983,507

(22) Filed: Dec. 29, 2015

Related U.S. Application Data
(60) Provisional application No. 62/097,698, filed on Dec. 30, 2014.

(51) Int. Cl. A01G 13/00

(52) U.S. Cl. CPC A01G 13/00

(57) ABSTRACT

The present invention relates to systems and methods of protecting vegetation from machinery, tools, automobiles, and other hazards common in or near construction zones. In particular, the present invention provides an easily assembled vegetation protection system (VPS) that is designed to adjustably surround and protect vegetation of varying size and shape, e.g., a tree trunk. Such systems may be subsequently stored either in assembled or disassembled form. Moreover, the VPS of the present invention may be prefabricated to offer a readily reusable device that is easy to install, adjust, and remove; and, upon removal, is immediately available for storage and/or additional/subsequent use.

### RELATED APPLICATIONS

This application claims priority to U.S. Provisional Patent Application No. 62/097,698, filed on Dec. 30, 2014, under Attorney Docket No. JHX-001-1; the entirety of which is incorporated herein by reference.

### BACKGROUND OF THE INVENTION

Plants and trees growing in urban areas are valued for their aesthetics as well as for providing shade and controlling soil erosion. Plant life in urban settings often requires more than customary attention to maintain plant health. One of the greatest causes of decline and death of plants and trees in urban areas is construction, necessitating the need to protect vegetation from hazards associated with such an environment.

In fact, many states and municipalities mandate the protection of plants and trees that are located in or near construction zones. Make-shift chain link fencing, plastic fencing and rudimentary wooden cladding are often assembled as temporary protection structures. However, these protectors are typically dismantled at the end of construction work, and are wastefully discarded since such material is not appropriate for storage and re-use.

Although tree and plant protecting products are currently available on the market for animal deterrence, these existing fabric, burlap, paper or plastic tape-type wraps offer no protection against machinery and tools. Moreover, such products are not suitable for protecting plants from machinery, tools and other hazards common at construction sites in compliance with the requirements mandated by states and/or municipalities. Consequently, existing products that may deter deer, rabbits or rodents from causing damage are clearly not robust enough to protect plants, trees and tree trunks located in or near construction and development zones.

As such, there is a definitive need for systems for protecting plants, trees, and tree trunks from machinery, tools, and other hazards common in construction zones, which may also be stored and re-used.

### SUMMARY OF THE INVENTION

The present invention relates to systems and methods of protecting vegetation from machinery, tools, automobiles, and other hazards common in or near construction zones. In particular, the present invention provides an easily assembled vegetation protection system (VPS) that is designed to adjustably surround and protect vegetation of varying size and shape, e.g., a tree trunk. Such systems may be subsequently stored either in assembled or disassembled form. Moreover, the VPS of the present invention may be prefabricated to offer a readily reusable device that is easy to install, adjust, and remove/uninstall; and, upon removal, is immediately available for storage and/or additional/subsequent use.

Accordingly, one aspect of the invention provides a vegetation protection system (VPS), comprising a vertical support scaffold (VSS); and a protective barrier material capable of being operationally associated with the VSS. The protective barrier material is securely associated with a reversible closure mechanism suitable for reversibly connecting one lateral end of the protective barrier material to the other lateral end of the protective barrier material. Further, the protective barrier material comprises one or more linkable barrier material segments, and which provides a protective barrier for vegetation upon engaging the closure mechanism after vertically encircling the vegetation with the protective barrier material.

Another aspect of the invention provides a prefabricated vegetation protection barrier assembly (PVPA), comprising a protective barrier material operationally associated with a vertical support scaffold (VSS). The protective barrier material is securely associated with a reversible closure mechanism suitable for reversibly connecting one lateral end of the protective barrier material to the other lateral end of the protective barrier material. Further, the protective barrier material comprises one or more linkable barrier material segments, and which provides a protective barrier for vegetation upon engaging the closure mechanism after vertically encircling the vegetation with the protective barrier material.

In another aspect, the invention provides a tool-free method for protecting vegetation. The method comprises the steps of: obtaining a PVPA of the invention to encircle the vegetation in need of protection, encircling the vegetation, and securing said PVPA around the vegetation by engaging the reversible closure mechanism.

### BRIEF DESCRIPTION OF THE DRAWINGS

Advantages of the present apparatus will be apparent from the following detailed description, which description should be considered in combination with the accompanying drawings, which are not intended limit the scope of the invention in any way. The Figures are described in greater detail in the Exemplification section

FIG. 1, a top down plan view perspective of certain particular embodiments of a prefabricated vegetation protection barrier assembly (PVPA) of the invention.

FIG. 2, an elevation view perspective of the particular embodiment depicted in FIG. 1 of a prefabricated vegetation protection barrier assembly (PVPA) of the invention, wherein the reversible closure mechanism is more easily discernable.

FIG. 3 depicts a sketched example of a particular embodiment of a PVPA of the present invention, comprising a trapezoidal protective barrier material, wherein the reversible closure mechanism comprises hook and loop closure components.

FIG. 4 depicts a sketched example of a particular embodiment of a barrier material segment of the present invention, comprising a trapezoidal protective barrier material, in which struts may be inserted or removed, and which struts extend beyond the height of the protective barrier. The reversible closure mechanism comprises hook and loop closure components that may be reversible coupled to other barrier material segments vertically or laterally.

FIG. 5 depicts a sketched example of a particular embodiment of two barrier material segments of the present invention, shown for easy visualization of alignment to encircle vegetation.

FIG. 6 depicts a sketched example of a particular embodiment of a PVPA of the present invention comprising a trapezoidal protective barrier material, wherein the struts may be inserted or removed, and which struts extend beyond the height of the protective barrier. The reversible closure mechanism comprises hook and loop closure components are positioned along the upper and lower lengths that are designed to reversibly couple with the hook and loop component positioned on a lateral edge upon encircling the vegetation.

### DETAILED DESCRIPTION OF THE INVENTION

The present invention relates to systems and methods of protecting vegetation from machinery, tools, automobiles, and other hazards common in or near construction zones. Moreover, the present invention fills a need in the construction industry, which currently does not have access to a readily-reusable, convenient, easy to use, sturdy, or adjustable system or prefabricated device to protect vegetation, e.g., plants, shrubs, bushes, and trees, from the hazards present in these construction zones.

For example, the present invention provides an easily assembled vegetation protection system (VPS) that is designed to adjustably surround and protect vegetation of varying size and shape, e.g., a tree trunk. Such systems may be subsequently stored either in assembled or disassembled form. Moreover, the VPS of the present invention may be prefabricated to offer a readily reusable device that is easy to install, adjust, and remove; and, upon removal, is immediately available for storage and/or additional/subsequent use.

In contrast to current plant/tree protection methods used, which are cumbersome to construct and adjust, and which are typically discarded at the end of the construction work, the vegetation protection systems (VPS) of the invention are easy to install, adjust, remove, store, and are readily-reusable. As such, the VPS of the present invention are ecologically and environmentally friendly.

The present invention, including systems, devices and methods will be described with reference to the following definitions that, for convenience, are set forth below. Unless otherwise specified, the below terms used herein are defined as follows:

### I. DEFINITIONS

As used herein, the term “a,” “an,” “the” and similar terms used in the context of the present invention (especially in the context of the claims) are to be construed to cover both the singular and plural unless otherwise indicated herein or clearly contradicted by the context.

The term “about,” is used herein to indicate variability of ±1% surrounding the designated value.

The term “adjustable” is used herein to describe the feature or ability of a material, e.g., any component of the VPS of the invention (e.g., the protective barrier material), to be loosened, tightened, raised and/or lowered around vegetation as needed.

The term “breathable” is used herein to describe the porosity of a material to allow air and other gases to pass through. In certain embodiments, the breathable material employed in the VPS of the invention also allows water and other liquids to drain away from the vegetation and VPS.

The terms “compress” or “compressible” are art recognized, and used herein to describe the ability of a material to be pressed, or pressed upon, to become distorted, flattened or otherwise changed in shape. Material that is compressed may become reduced in size or volume, flattened laterally, or narrowed from side to side. Compression may distort a material in an irreversible or reversible manner. A given material may be compressed in an irreversible manner when, after the compressing force is removed, the material remains distorted, flattened or otherwise changed in shape or condition. A given material may be compressed in a reversible manner when, after the compressing force is removed, the material does not remain distorted, flattened or otherwise changed in shape but returns in part or in full to its original shape or condition before compression.

The term “damage” is used herein to describe any injury or harm, e.g., to vegetation. The damage may or may not be visible to the naked eye. For example, damage may cause the vegetation to become visually unappealing, and/or may cause a portion of or all of the vegetation to die. The injury or harm may render the vegetation of less value or less useful.

The term “durable” is art recognized and is used herein to describe the feature or ability of a material, e.g., any component of the VPS of the invention (e.g., the protective barrier material), to stay strong and in good condition over a long period of time, to exist for a long time and several uses without significant deterioration or loss of protective ability.

The term “encircle” is art recognized, and is used herein to describe the feature and ability of an item, e.g., the VPS of the invention, to form a circle around or surround another item, e.g., vegetation in need of protection.

The term “fire-resistant” is art recognized, and is used herein to describe the feature and ability of an item, e.g., the VPS of the invention, to resist being burnt, burned, or destroyed or rendered inoperable by exposure to fire and flame.

The term “flexible” is art recognized, and used herein to describe the fluidity or lack of stiffness of a material or substance, e.g., in any layer or portion of the VPS. A flexible material is one that can be folded, rolled, bent, draped, crushed or the like. For example, the flexible protective barrier material employed in the VPS or PVPA of the present the invention is one that is supple enough to be wrapped around and encircle an object, such as a cylindrical object, e.g., the trunk of a tree.

As used herein, the term “tool” as used in the context of the present invention describes device or implement, e.g., any hand tool, which are commonly associated with construction sites or development sites. The term “tools” may include, but are not limited to hand tools which are commonly used to twist, manipulate or cut materials such as metal wire or plastic strings or ties that are not easily manipulated only by hand. For example, tools include pliers, screwdrivers, wire cutters, loppers, snippers, scissors, hammers, hand saws of any type, axes, razor blades, knives of any type, e.g., box knives, and the like, or any combination thereof.

As used herein the phrase “lateral edge” refers to the edge of the VPS of the invention which is aligned with the vertical struts of the VPS. When the VPS is in place around vegetation in need of protection, the lateral edges are those edges which are essentially parallel with the vegetation and essentially perpendicular to the ground.

The term “layer” is art recognized, and is used herein to describe a defined region, thickness, or covering. This term is also used to differentiate between material on the exterior and the interior of the protective barrier material of the VPS of the invention, and as such, the term “exterior layer” may comprise two or more single sheets of material joined together to form a single exterior layer. Alternatively, the “interior layer” is defined by the region that is contained within the exterior layer, e.g., which may further comprise the VSS of the invention

The term “operationally associated” is used herein to describe items that are associated, connected, or related in such a manner as to achieve a common intended purpose of operation of the items together. For example, the protective barrier material of the vegetation protection systems of the invention may be operationally associated with the vertical support scaffold (VSS) wherein the two components are connected in such a way, e.g., through linking hardware or material design, as to position the barrier in a vertical manner along the vertically positioned VSS as to afford the ability of the protective barrier material together with the VSS to protect the vegetation.

The term “prefabricated” is used herein to describe an item, e.g., the prefabricated vegetation protection barrier assembly of the invention, in which the parts of the item or the item are completely or partially assembled prior to arriving in the hands of a user/purchaser such that the item is immediately ready for use or in which minimal assembly is required prior to use by the end user.

The term “pocket” is art recognized, and used herein to describe an item or portion of an item, comprising a defined space with an opening that allows insertion of an item through said opening and into said space, and removal of said item through said opening from said space. In certain embodiments, a pocket may be formed by securing a material layer or portion of the layer along some or most of the defined pocket area, e.g., along three sides of a rectangle, while some remaining portion of the area remains unsecured, forming the opening.

As used herein, the term “readily-reusable” is used to describe the speed, ease and convenience with which the VPS or PVPA of the invention may be reused. For example, in certain embodiments, the term refers to the speed, ease and convenience with which the VPS or PVPA may be unsecured and removed from the vegetation, e.g., by opening the reversible closure mechanism, and being immediately or nearly immediately in a state of readiness for protecting the same or different vegetation.

As used herein, the term “reversible,” describes any mechanism or action that may be utilized to repeatably place a given item or items in one of two possible states, indefinitely. For example, a latch may be open or closed, hook and loop fasteners may be separate/open or fastened; these closure mechanisms are considered reversible.

As used herein, the language “reversible closure mechanism,” describes any closure mechanism that may be repeatably placed in an open or closed position, indefinitely. Such mechanism is suitable for securing the VPS in place around vegetation and may include, for example, hook and loop (e.g., VELCRO®), a buckle, a tie, a zipper, a ratchet-type binding, tape, button, hook and eye, elastic material, a snap, and the like, or any combination thereof. The reversible closure mechanism, when in the closed secured position, is considered to be engaged, e.g., hook and loop fasteners are position so that the hook and loop sides are connected. The reversible closure mechanism, when in the open unsecured position, is considered to be disengaged, e.g., hook and loop fasteners are position so that the hook and loop sides are not connected; however, the reversible closure mechanism per se remains securely associated with the protective barrier material.

The term “rigid” is art recognized, and used herein to describe the feature or ability of a material that is stiff, solid, and lacks flexibility. In certain embodiments, a rigid material is not able to be folded, rolled, bent, draped, or crushed. In certain embodiments, the vertical support scaffold, e.g., strut, comprises a rigid material.

The term “secure” is art recognized, and used herein to describe a state of tight association by firm fixation, fastening, or through operational association. In certain embodiments, the VPS is secure when it is surrounding vegetation and the reversible closure mechanism is closed, connected or latched in the manner suitable, or compatible, for the particular reversible closure mechanism.

The language “securely associated” is used herein to describe a particular embodiment of operational association in which the two items that are operationally associated are linked in such a manner as to provide equal or greater strength in manner of connection of the two items as compared with the internal strength that each item possesses. Accordingly, such junction assures the secure nature of the union of the two items, and imports a high degree of difficulty of removing one item attached to or associated with another item. In certain embodiments, the components of the reversible closure mechanism are securely associated with the protective barrier material, e.g., the outer or inner face of the protective barrier material.

The term “semi-rigid” is art recognized, and used herein to describe the feature or ability of a material that is stiff and solid, but not inflexible. In certain embodiments, the vertical support scaffold, e.g., strut, comprises a semi-rigid material. Comparatively, semi-rigid material is not as stiff or inflexible as a rigid material.

The term “shred-proof” is used herein to describe the feature or ability of a material, e.g., any component of the VPS of the invention (e.g., the protective barrier material), to be essentially impervious to shredding, e.g., upon contact with hazards at a construction site the protective barrier material remains intact.

The term “shred-resistant” is used herein to describe the feature or ability of a material, e.g., any component of the VPS of the invention (e.g., the protective barrier material), to not be easily shredded, e.g., upon contact with hazards at a construction site the protective barrier material resists shredding to greater extent to remain at least partially intact.

The term “sleeve” is art recognized, and is used herein to describe an item or portion of an item, comprising a defined tubular space with at least one opening defined by walls designed to enclose a rod, spindle, tube, pole, or related shapes that may fit within the tubular shape, which allows insertion of an item, e.g., strut, through the opening and into said space, and removal of said item through the opening from said space. In particular embodiments, the sleeve has two openings, e.g., one at the top of the protective barrier material and one at the bottom of the protective barrier material.

The terms “stretch” and “stretchable” are art recognized and are used herein to describe the feature or ability of a material, e.g., any component of the VPS of the invention (e.g., the protective barrier material), to lengthen, widen, distend or be enlarged by tension, to extend over a distance or area in one or more directions. In certain embodiments, the VPS of the invention may be stretched in a reversible manner, e.g., the stretched item returns, in whole or in part, to the pre-stretched shape or state.

The term “strut” is art recognized and is used herein to describe a rod or bar forming part of a framework and designed to resist compression, comprising any rigid or semi-rigid material oriented in a manner as to provide support, shape, and structure, e.g., to VPS of the invention. In certain embodiments of the invention, the vertical support scaffold comprises one or more struts to afford vertical structural support for the VPS or PVPA of the present invention.

The term “sturdy” is art recognized and is used herein to describe the feature or ability of a material, e.g., any component of the VPS of the invention (e.g., the protective barrier material) to exhibit strength. In reference to an item such as the VPS of the invention, sturdy describes the strength, ruggedness, stability, firmness and/or vigor of said item.

The term “trunk” is art recognized, and is used herein to describe the base of a tree. The trunk of a tree may consist of one single trunk structure or may be split into two or more vertical trunk sections.

The term “vegetation” is art recognized, and used herein to describe any higher plant life form, or part thereof, which is capable of being encircled by a VPS of the invention. Types of plants include, but are not limited to, trees, saplings, flowering plants, vegetables and vegetable plants, shrubs, bushes, caning plants, vining plants, ground covers, grasses and the like. Plant parts include, but are not limited to, roots, tubers, corms, bulbs, shoots, stems, branches, leaves, needles, blades, trunks, flowers, fruit, seeds or grains, pods, bark, burls and the like.

The term “water-proof” is art recognized and is used herein to describe the feature or ability of a material, e.g., any component of the VPS of the invention (e.g., the protective barrier material), to be impermeable to water, to prevent water from entering or passing through, or to be designed such that water alone will not remove, harm or destroy the barrier material.

The term “water-resistant” is art recognized and is used herein to describe the feature or ability of a material, e.g., any component of the VPS of the invention (e.g., the protective barrier material), to not be easily harmed or affected by water; to not allow water to easily enter or pass through; or to be designed such that water alone will not easily remove, harm or destroy the material.

The term “weather-proof” is art recognized and is used herein to describe the feature or ability of a material, e.g., any component of the VPS of the invention (e.g., the protective barrier material), to be able to withstand exposure to any kind of weather without substantial deterioration or loss of usefulness. A weather-proof VPS of the invention, or any component thereof, is characterized by one or more of the properties selected from the ability to withstand heat, cold, freezing temperatures, changes in temperature, rain, sleet, snow, hail, freezing rain, wind, humid or dry air conditions, exposure to sun and UV radiation, and the like.

The term “height,” as used herein describes a dimension measurement that is defined in the vertical direction relative to the ground adjacent to the vegetation on which the assembled system would be positioned for encircling the vegetation. For example, the height of the VPS is measured in the direction that is substantially parallel to the trunk of a tree and perpendicular to the ground.

The term “length,” as used herein describes the dimension measurement that is defined in the horizontal direction relative to the ground adjacent to the vegetation on which the assembled system would be positioned for encircling the vegetation. For example, the length of the VPS is measured in the direction that is substantially parallel with the soil or ground and perpendicular to the trunk of a tree. In certain embodiments, the length of the VPS of the invention is selected to be the circumferential distance necessary to encircle the widest circumference of the vegetation, e.g., the widest portion of a shrub, tree or tree trunk.

The term “width,” as used herein describes a measurement of the thickness of the VPS as defined by the protective barrier(s) plus the vertical support scaffold, and in certain embodiments, any additional layers that comprise the assembled VPS.

The Vegetation Protection System of the Invention

The present invention relates to systems useful for protecting vegetation in or near construction zones from machinery, tools, automobiles, and other hazards common in or near construction zones. In particular, the present invention provides an easily assembled vegetation protection system (VPS) that is designed to adjustably surround and protect vegetation of varying size and shape, e.g., a tree trunk. The vegetation protection systems of the present invention are engineered to be readily-reusable.

As such, one embodiment of the present invention provides a vegetation protection system (VPS), comprising a vertical support scaffold (VSS); and a protective barrier material capable of being operationally associated with the VSS, wherein the protective barrier material is securely associated with a reversible closure mechanism suitable for reversibly connecting one lateral end of the protective barrier material to the other lateral end of the protective barrier material, and wherein the protective barrier material comprises one or more linkable barrier material segments, and which provides a protective barrier for vegetation upon engaging the closure mechanism after vertically encircling the vegetation with the protective barrier material.

In certain embodiments, the vegetation is selected from the group consisting of plants, shrubs, bushes, saplings, trees, tree trunks, and any combination thereof.

In certain embodiments of the invention, the vegetation is a tree, e.g., wherein the trunk of the tree is protected.

In certain embodiments, the VPS of the present invention is designed to conform to the tree cladding requirements of a federal, state or municipal guideline. For example, many municipalities mandate the protection of plants, and of trees in particular, that are located in construction zones. In certain embodiments, the VPS serves as a direct replacement/substitute for trunk protection cladding by 2×4 or 2×3 nominal lumber (e.g., at least 6 feet in length) that is bound together with wire and used in attempt to protect a tree trunk from construction activities.

Accordingly, the components of the vegetation protection system comprise a vertical support scaffold, a protective barrier material, and a closure mechanism that afford protection to vegetation upon the encircling of the vegetation. Such components may be selected such that the VPS of the present invention is capable of performing its intended function, e.g., protecting vegetation, e.g., from construction hazards. The system may also be assembled into a prefabricated vegetation protection barrier assembly (PVPA), which may be stored and reused, or, in certain embodiments, disassembled for storage.

The vegetation protection system of the invention may be selected and assembled to protect vegetation of varying size and shape. As such, the vegetation, in certain embodiments, may dictate the composition of the vegetation protection system or the prefabricated vegetation protection barrier assembly. In particular, the vegetation may be of different shapes or forms, including, but not limited to columnar, fastigate, oval, pyrimidal, round, oval, vase, fountain, weeping, or irregular.

In certain embodiments, the vegetation protection systems of the present invention are engineered to protect against hazards of a construction zone. For example, such hazards include, but are not limited to any tool, e.g., sharp tools of any kind, machinery, or item commonly associated with construction sites or development sites. In a particular embodiment the hazard may include, but is not limited to large tools, sharp tools of any type, hand tools of any type, bulldozers, backhoes, front loaders, skid steers, trucks or vehicles of any type, saws of any type including chain saws, nails and nail guns, axes, blades of any type, shovels, hoes, glass, stiff plastics, concrete blocks, metal bars or beams, cranes, girders, large pieces of wood, and the like, or any combination thereof, which, upon contact with vegetation e.g., a tree or tree trunk, is capable of causing damage to the vegetation.

The dimensions of the VPS, such as height, length and width are defined by the component dimensions of the vertical support scaffold and the protective barrier material.

Although the VPS of the present invention is useful for the protection of vegetation, it may also be useful to encircle and/or protect other items, including support columns, for example in parking garages (i.e., parking garage posts), and the posts of basketball backboards/rims, as well as chairlift columns. Such uses are intended to be included within the scope of the present invention.

A. Vertical Support Scaffold (VSS)

The vertical support scaffold (VSS) of the vegetation protection system (VPS) of the invention provides the rigid or semi-rigid structural component of the system when operationally associated with the protective barrier material. In certain embodiments, the vertical support scaffold (VSS) comprises one or more struts that are operationally associated with the protective barrier material which, when in place and in operation together, offer support from the ground/soil and extend up along vegetation in a vertical direction essentially in parallel with the vegetation and perpendicular to the soil or ground. In certain embodiments, the VSS provides rigidity to the barrier material and the VPS as a whole.

In certain embodiments the vertical support scaffold is a single vertical structure that provides support to the VPS when operationally associated with the protective barrier material. The vertical structure may take any shape necessary for the vertical support scaffold to perform its intended function. For example, the vertical structure may comprise a single unit that substantially matches in size the protective barrier material, or may alternatively comprise a single strut.

In certain embodiments the vertical support scaffold comprises multiple separate vertical structures that provide support to the VPS when operationally associated with the protective barrier material. The vertical structures may take any shape necessary for the vertical support scaffold to perform their intended function. For example, the vertical structure may comprise multiple units that approximate in size, when viewed in combination, the protective barrier material, or may alternatively comprise multiple struts.

In certain embodiments of the invention, the vertical support scaffold (VSS) comprises one vertical strut. In particular embodiments, the strut is of any diameter capable of being operationally associated with the protective barrier material, for example, a diameter of about 1 to 4 inches, e.g., 1 inch, 1.5 inches, 2 inch, 2.5 inches 3 inches, 3.5 inches, or 4 inches in diameter.

In certain embodiments of the invention, the vertical support scaffold (VSS) comprises two or more vertical struts. In particular embodiments, the struts may be the same or different, and may be of any diameter capable of being operationally associated with the protective barrier material, for example, a diameter of about 1 to 4 inches, e.g., 1 inch, 1.5 inches, 2 inch, 2.5 inches 3 inches, 3.5 inches, or 4 inches in diameter.

The vertical support scaffold, e.g., comprising one or more struts, is constructed of a material that is rigid or semi-rigid. In certain embodiments, the vertical support scaffold, e.g., strut, comprises a rigid material, which may include, for example, wood, e.g., a 2×4 board, metal (e.g., pipes or poles), plastic (e.g., pipes or poles, e.g., PVC piping, e.g., solid core piping), or any combination thereof. In certain embodiments, the vertical support scaffold, e.g., strut, comprises a semi-rigid material, which may include, for example, one or more types of plastic material, e.g., pipes (e.g., PVC piping) or foams (e.g., polymeric foams). In certain embodiments, given an increased stiffness, e.g., due to increased density, certain foams may be considered a rigid material, and are intended to be within the scope of the present invention.

In certain embodiments of the invention, the VPS is designed such that one type of strut material may be interchanged for another type of strut, e.g., PVC piping and 2×4 wooden boards.

In certain embodiments wherein the vertical support scaffold is one or more struts, the strut is PVC pipe of any diameter capable of being operationally associated with the protective barrier material, for example, a diameter of about 1 to 4 inches, e.g., 1 inch, 1.5 inches, 2 inch, 2.5 inches 3 inches, 3.5 inches, or 4 inches in diameter. In one particular embodiment, the PVC pipe is 1.5 inches in diameter.

The vertical support scaffold may be a separate structure that is not an integrated component of the protective barrier material; i.e., it may be reversibly positioned to be operationally associated with the protective barrier material. For example, the vertical struts may be fastened to the protective barrier material through any means capable of operationally associating the struts to the protective barrier material, such as through hardware, through stitching, through heat welding, or through glue. Such stitching, welding, or glue may create pockets, cuffed/stitched rings (one or a set of two or more that can receive and maintain the VSS, e.g., strut, in position), or sleeves in which the vertical support scaffold may be placed/positioned. In certain embodiments, each pocket or sleeve may house one or more struts. In a specific embodiment, one strut is housed per pocket or sleeve.

In certain embodiments, the struts may be supported by a basal support or the ground. In particular embodiments, the struts are designed be positioned on top of the ground. In particular embodiments, the struts are designed be positioned in the ground. In particular embodiments, the struts are designed to be positioned in a base/basal support structure that is engineered to sit on the ground and receive one or more struts.

The vertical support scaffold, e.g., strut, of the VSS may be integrated into or be an integral component of the protective barrier material. For example, the vertical support scaffold may be entirely and permanently contained within the protective barrier material, e.g., the VSS may comprise a semi-rigid or rigid foam-type material, e.g., polyethylene, polyurethane, or polystyrene. In a specific embodiment, the foam may be a multi-composite foam comprising denser, less-flexible foam-type to serve as the vertical struts with less dense foam in between the vertical supportive strut foam sections, e.g., molded into or formed as part of the protective barrier material.

In certain embodiments, the vertical support scaffold is operationally associated with the protective barrier material at least at one location/fastener, e.g., at any location along the length of the protective barrier material, such as in the center of the protective barrier material and/or at either or both ends of the protective barrier material.

In certain embodiments, the VSS is configured such that each vertical strut of the VSS does not extend beyond the protective barrier material.

In certain embodiments, the VSS is configured such that each vertical strut of the VSS extends from the bottom of the protective barrier material to the top of the protective barrier material, e.g., internally between two layers of outer protective barrier material in a sleeve, reversibly or as an integrated component

In certain embodiments, one or more vertical struts extend beyond the protective barrier material, e.g., internally between two layers of outer protective barrier material in a sleeve, reversibly. In a particular embodiment, each vertical strut extends beyond the protective barrier material.

In certain embodiments, the struts are unevenly spaced along the length of the VPS.

In certain embodiments, the struts are evenly spaced along the length of the VPS.

In one embodiment, the protective barrier material is configured to receive 1 to 40 struts, e.g., 2 to 30 struts, e.g., 2 to 20 struts, e.g., 4 to 15 struts, e.g., 6 to 10 struts. In certain embodiments, the protective barrier material is configured such that the struts are not placed closer than about 6 inches to each lateral edge of the protective barrier material when operationally associated. In certain embodiments, the protective barrier material is configured such that the struts are evenly spaced along the length of the protective barrier material, e.g., spaced about 3 inches apart from center to center. In a particular embodiment, the structures are held in place in pockets or sleeves formed by stitching running from the top to the bottom, evenly spaced between the struts. In a specific embodiment, the struts, e.g., 1.5 inch diameter PVC pipe, are contained in a 2-layer protective barrier material, e.g., placed about 3 inches apart on center.

In certain embodiments, the protective barrier material is 18 inches in length and comprises 5 struts.

In certain embodiments, the protective barrier material is 24 inches in length and comprises 7 struts.

In certain embodiments, the protective barrier material is 36 inches in length and comprises 10 struts.

In certain embodiments, the protective barrier material is 4.25 feet in length and comprises 13 struts.

B. Protective Barrier Material

The protective barrier material of the vegetation protection systems of the invention is the material positioned in the system to create the primary barricade between the vegetation being protected and any potential hazards, e.g., present at construction sites, when operationally associated with the vertical support scaffold. The protective barrier material is sufficiently flexible enough to encircle vegetation, and serves as a housing or an interconnecting substructure for the vertical support scaffold.

The protective barrier material of the VPS of the invention comprises one or more layers of any material that exhibits suitable characteristics to provide protection to vegetation, e.g., in need of protection. As such, the protective barrier material is selected from materials that are sturdy, durable, strong, flexible, weather-proof, water-proof, water-resistant, shred-resistant, shred-proof, breathable, fire resistant, stretchable, compressible, reflective, or any combination thereof. In a particular embodiment, the material is sturdy, flexible, weather-proof, water-proof, water-resistant, shred-resistant, breathable, fire resistant, stretchable, compressible, reflective, or any combination thereof. In certain embodiments, the barrier material is shred-resistant or shred-proof to protect from damage by machinery, tools, sharp objects, metal bars or beams, saws, knives, rodents and the like.

In certain embodiments of the invention, the material is selected from the group consisting of cloth (for example, any woven or felted fabric made from any fiber, including cotton, nylon or burlap, e.g., untreated 8-ounce burlap or hemp), plastic (e.g., polyethylene or polypropylene), and any combination thereof.

In one embodiment of the present invention, the protective barrier material of the VPS is a single layer formed from a single sheet of material. The layer of protective barrier material is operationally associated with the VSS, e.g., through a fastening means, and securely associated with a reversible closure mechanism.

In one embodiment of the present invention, the protective barrier material of the VPS is two or more layers formed from two or more sheets of material. In another embodiment, the protective barrier material comprises two exterior sheets of material that are joined together in some fashion, e.g. by stitching, to form the protective barrier material. For example, in certain embodiments, wherein the two or more sheets of material are polyethylene, they may be formed into the protective barrier material through welding, e.g., hot gas, infrared, laser or ultrasonic welding, heat sealing, heat fusing or any combination thereof. In certain embodiments, the protective barrier material further comprises an internal layer within the area defined by the two exterior layers, where the internal layer is configured to receive a strut and retain the strut in substantially fixed position. In a particular embodiment, the internal layer comprises a material, or combination of materials, capable of receiving a strut and retaining the strut in substantially fixed position. In a specific embodiment, the internal layer comprises a foam material such as polyethylene, polyurethane, polystyrene and the like. In certain embodiments, the protective barrier material is configured to allow insertion and removal of the struts from the protective barrier material.

In certain embodiments of the protective barrier material comprising two or more layers of material, the individual sheets forming the layers are positionally matched, e.g., at all four corners, and attached to each other along the entire length of all four edges of the protective barrier material, e.g., encasing the one or more vertical structures or struts in a substantially fixed position. The sheets may be securely joined to each other by any suitable bonding attachment such as sewing, stapling, riveting, gluing, fusing and the like, or any combination thereof. For example, in one embodiment, the sheets are secured along the entire length of all four edges of the VPS by stitching or sewing.

In certain embodiments of the protective barrier material comprising two or more layers of material, the VSS comprises one or more struts which are completely enclosed within the internal layer within the area defined by the two exterior layers, e.g., such that the number of struts are spaced along the length of the protective barrier material, e.g., each strut is separated from the adjacent strut by any suitable bonding attachment of the inner and outer layers, such as sewing, stapling, riveting, gluing, fusing and the like, or any combination thereof. In one particular embodiment, the adjacent struts are separated by stitching running the entire height of the protective barrier material.

In certain embodiments of the protective barrier material comprising two or more layers of material, the individual sheets forming the layers are joined together around the periphery in such a manner as to form one or more pockets to house the at least one strut in which the strut may be removed and reinserted. For example, the individual sheets forming the layers may be positionally matched, e.g., at all four corners, and attached to each other along the entire length of three edges, e.g., each side and the bottom, leaving the one edge open, e.g., the top edge, to access the pockets. The sheets may be securely bonded or attached to each other by any suitable attachment such as sewing, stapling, riveting, gluing, fusing and the like, or any combination thereof. In one embodiment, the layers are stitched or sewn together. In a specific embodiment, each side and the bottom edge of the pocket are attached (i.e., leaving the top open).

In certain embodiments of the protective barrier material comprising two or more layers of material, the individual sheets forming the layers are joined together around the periphery in such a manner as to form one or more sleeves to house the at least one strut in which the strut may be removed and reinserted. For example, the individual sheets forming the layers may be positionally matched, e.g., at all four corners, and joined together along the entire length of two edges of each lateral side, and most of the length of the top and bottom sides, leaving at least one opening at the top and/or bottom edge of the peripherally joined edges to form an opening for a sleeve. The sheets may be securely bonded or attached to each other by any suitable attachment such as sewing, stapling, riveting, gluing, fusing and the like, or any combination thereof. To form each sleeve, the sheets are secured to each other for the entire height of the protective barrier material in groups of two by any suitable attachment such as sewing, stapling, riveting, gluing, fusing and the like, or any combination thereof. In one embodiment, the layers are stitched or sewn together in a linear manner from the bottom of the protective barrier material to the top of the protective barrier material. The struts of the VPS comprising one or more sleeves may also extend beyond the height of the VPS, that is, may extend above the top edge, extend below the bottom edge, extend above the top and extend below the bottom edges, or any combination thereof. In particular embodiments, the one opening at the top or bottom edge of the peripherally joined edges that form an opening for a sleeve in which a strut may be placed, is sealed after a strut has been placed in position, resulting in a fully non-removable integrated strut.

Each pocket or sleeve may house one or more struts. In one embodiment, one strut is housed per pocket or sleeve. The pockets or sleeves are the width necessary to accommodate the strut and may be about 1 or more inches, e.g., about 2 or more inches, e.g., about 3 or more inches, e.g., about 4 or more inches, e.g., about 5 or more inches, e.g., about 6 or more inches, e.g., about 7 or more inches, e.g., about 8 or more inches, e.g., about 9 or more inches, e.g., about 10 or more inches, e.g., about 11 or more inches, e.g., about 12 inches, in width. In a particular embodiment, the pockets or sleeves are about 3 inches in width.

The pockets or sleeves may be evenly spaced across the width of the VPS or the pockets or sleeves may be unevenly spaced. In one embodiment, the pockets or sleeves are adjacent to each other. In another embodiment, the pockets or sleeves are not adjacent to each other. In one embodiment, the pockets or sleeves are spaced such that the center of a given pockets or sleeves is about 3 inches from the center of an adjacent pockets or sleeves. In one embodiment, the pockets or sleeves are not placed closer than about 6 inches to each lateral edge of the VPS. In one embodiment, the protective barrier material is configured, e.g., using a sleeve, to receive 1 to 40 struts, e.g., 2 to 30 struts, e.g., 2 to 20 struts, e.g., 4 to 15 struts, e.g., 6 to 10 struts. In a particular embodiment, the structures are held in place in pockets or sleeves formed by stitching running from the top to the bottom, evenly spaced between the struts. In a specific embodiment, the struts, e.g., 1.5 inch diameter PVC pipe, are contained in a 2-layer protective barrier material, e.g., placed about 3 inches apart on center.

In certain embodiments, the protective barrier material is 18 inches in length and comprises sleeves for 5 struts.

In certain embodiments, the protective barrier material is 24 inches in length and comprises sleeves for 7 struts.

In certain embodiments, the protective barrier material is 36 inches in length and comprises sleeves for 10 struts.

In certain embodiments, the protective barrier material is 4.25 feet in length and comprises sleeves for 13 struts.

In one embodiment, a VPS is designed such that at least one strut is fully encased in the protective barrier material, e.g., at least one strut is enclosed in a pocket or sleeve.

In certain embodiments of the VPS, the protective barrier material further comprising one or more additional layers, e.g., that add functionality to the protective barrier material. In certain embodiments, the additional layer is created by joining additional sheets to the protective barrier material.

The height of the protective barrier material is any height that protects the vegetation, e.g., in need of protection. One or more linkable barrier material segments may be employed to achieve a desired height for the VPS. In one embodiment, the protective barrier material is about 1 or more feet, e.g., about 2 or more feet, e.g., about 3 or more feet, e.g., about 4 or more feet, e.g., about 5 or more feet, e.g., about 6 or more feet, e.g., about 7 or more feet, e.g., about 8 or more feet, e.g., about 9 or more feet, e.g., about 10 or more feet, e.g., about 11 or more feet, e.g., about 12 feet, in height. In one particular embodiment, the protective barrier material is about 8 feet in height.

The length of the protective barrier material is any length that surrounds, encircles the vegetation at the widest circumference of the vegetation. One or more linkable barrier material segments may be employed to achieve a desired length for the VPS. In one embodiment, the protective barrier material is about 1 or more feet, e.g., about 2 or more feet, e.g., about 3 or more feet, e.g., about 4 or more feet, e.g., about 5 or more feet, e.g., about 6 or more feet, e.g., about 7 or more feet, e.g., about 8 or more feet, e.g., about 9 or more feet, e.g., about 10 or more feet, e.g., about 11 or more feet, e.g., about 12 feet, e.g., about 20 feet, in length. In one particular embodiment, the protective barrier material is about 4 feet in length.

The protective barrier material may be of any length or shape to encircle vegetation so that the lateral edges of the VPS meet each other or that the lateral edges of the VPS may overlap, e.g., by at least one inch, e.g., at least about 2 inches, e.g., at least about 3 inches, e.g., at least about 4 inches, e.g., at least about 5 inches, e.g., at least about 6 inches, e.g., at least about 7 inches, e.g., at least about 8 inches, e.g., at least about 10 inches, e.g., at least about 1 foot, e.g., at least about 2 feet, e.g., at least about 4 feet, e.g., at least about 5 feet. In one embodiment, the VPS lateral edges overlap by about 6 inches.

In certain embodiments of the invention, the protective barrier material comprises one or more linkable barrier material segments, which may be linked to each other in one or more locations, e.g., through a secondary reversible closure mechanism. In a particular embodiment, the protective barrier material comprises one barrier material segment. The single barrier material segment is sufficient to provide a protective barrier for vegetation, e.g., in need of protection, upon engaging the reversible closure mechanism after vertically encircling the vegetation with the single barrier segment. In certain embodiments, the secondary reversible closure mechanism is the same mechanism as the reversible closure mechanism of the VPS.

In certain embodiments of the invention, the protective barrier material comprises two or more barrier material segments, which may be linked to each other in one or more locations, e.g., through a secondary reversible closure mechanism. The reversible closure mechanism may comprise a closure component on one barrier material segment that mates with a corresponding closure component on the same or different barrier material segment. The linked segments provide a protective barrier for vegetation, e.g., in need of protection, upon engaging the reversible closure mechanism after vertically encircling the vegetation with the single barrier segment. In certain embodiments, the secondary reversible closure mechanism is positioned, e.g., in addition to other locations, on the lateral edge of each barrier material segment, i.e., the lateral edges of each barrier material segment comprise a closure component that would mate with the corresponding closure component on different barrier material segment. In certain embodiments, the secondary reversible closure mechanism is the same mechanism as the reversible closure mechanism of the VPS. In certain embodiments, the secondary reversible closure mechanism is positioned, e.g., in addition to other locations, on the top and/or bottom edges of each barrier material segment. In certain embodiments, the barrier material segments are the same or different sizes/shapes, e.g., lengths.

The vegetation protection system of the invention can be used to protect a variety of vegetation of varying size and shape, including but not limited to plants, shrubs, bushes, saplings, trees and tree trunks. Accordingly, the protective barrier material, comprising a single or combination of multiple barrier material segments, may be any shape that can completely encircle the vegetation in need of protection. Thus, the protective barrier material may be rectangular, square, trapezoidal, triangular, rhomboid, or any other shape that allows the VPS to fully encircle the vegetation at the widest circumference. In certain embodiments of the invention, the protective barrier material comprises one or more linkable barrier material segments that are rectangular, square, trapezoidal, triangular or rhomboid in shape, e.g., which may be linked to each other to produce any useful shape of the protective barrier material suitable to protect vegetation.

In certain embodiments of the invention, the protective barrier material comprises one or more linkable barrier material segments, wherein at least one segment is rectangular in shape. In particular embodiments, the barrier material segment is a rectangular shape, in which the height of the rectangle is at least about 1.2, e.g., about 1.5, e.g., about 1.7, e.g., about 2, e.g., about 2.2, e.g., about 2.5, e.g., about 2.7, e.g., about 2.9, e.g., about 4 times the length of the rectangle. In a particular embodiment, the barrier material segment is a rectangular shape, in which the height of the rectangle is at least about 2, e.g., about 2.5, e.g., about 3, e.g., about 4 times the length of the rectangle. In one specific embodiment, the barrier material segment is rectangular in shape in which the height of the rectangle is at least about 2 times the length of the rectangle; for example, the barrier material segment is about 8 feet in height and about 4 feet in length. In another specific embodiment, the barrier material segment is rectangular in shape and is between about 4 to about 10 feet in height and between about 2 to about 20 feet in length, e.g., between about 6 to about 9 feet in height and between about 2 to about 10 feet in length, e.g., between about 6 to about 9 feet in height and between about 2 to about 5 feet in length or about 8 feet in height and about 4 feet in length.

In certain embodiments of the invention, the protective barrier material comprises one or more linkable barrier material segments, wherein at least one segment is square in shape, i.e., in which the height and length of the segment are about the same measurement. In particular embodiments, the barrier material segment is a square shape, in which each side is at least about 2, e.g., about 3, e.g., about 4, e.g., about 5, e.g., about 6, e.g., about 7, e.g., about 8, e.g., about 9, e.g., about 10 feet. In particular embodiments, the barrier material segment is a square shape, in which each side is at least about 4, e.g., about 5, e.g., about 6, e.g., about 7, e.g., about 8, e.g., about 9, e.g., about 10 feet. In a particular embodiment, the barrier material segment is a square shape in which each side is about 8 feet.

In certain embodiments of the invention, the protective barrier material comprises one or more linkable barrier material segments, wherein at least one segment is trapezoidal in shape. In particular embodiments, the barrier material segment is a trapezoid shape, in which the short length of the trapezoid is the upper length of the barrier material segment and is furthest from the ground, while the lower length of trapezoid is the long length of the barrier material segment and is closest to or touches the ground. In particular embodiments, the barrier material segment is a trapezoid shape, in which the short length of the trapezoid is the lower length of the barrier material segment and is furthest from the ground, while the upper length of trapezoid is the long length of the barrier material segment and is closest to or touches the ground. In particular embodiments, the barrier material segment is a trapezoidal shape, in which the long length of the trapezoid is at least about 1.05, e.g., about 1.1, e.g., about 1.2, e.g., about 1.3, e.g., about 1.4, e.g., about 1.5, e.g., about 1.6, e.g., about 1.7, e.g., about 1.8, e.g., about 1.9, e.g., about 2 times the short length of the trapezoid; and the height of the trapezoid is at least about 1.2, e.g., about 1.5, e.g., about 1.7, e.g., about 2, e.g., about 2.2, e.g., about 2.5, e.g., about 2.7, e.g., about 2.9, e.g., about 4 times either length of the trapezoid. In one specific embodiment, the barrier material segment is trapezoid in shape in which the height of the trapezoid is at least about 2 times either length of the trapezoid; for example, the barrier material segment is about 8 feet in height, about 4 feet in one length and about 4.4 feet in the opposing length.

In certain embodiments of the invention, the protective barrier material comprises one or more linkable barrier material segments, wherein at least one segment is a triangular shape, e.g., a right angle, equilateral, isosceles or scalene triangle. In particular embodiments, the barrier material segment is a triangular shape, in which the length of a first side of the triangle is at least about 1, e.g., about 1.05, e.g., about 1.1, e.g., about 1.2, e.g., about 1.3, e.g., about 1.4, e.g., about 1.5, e.g., about 1.6, e.g., about 1.7, e.g., about 1.8, e.g., about 1.9, e.g., about 2 times the length of either or both of the second and third sides of the triangle. In certain embodiments, the height of the triangle is at least about 0.1, e.g., about 0.2, e.g., about 0.5, e.g., about 0.8, e.g., about 1, e.g., about 1.2, e.g., about 1.2, e.g., about 1.5, e.g., about 1.7, e.g., about 2 times the length of any side of the triangle. In one specific embodiment, the barrier material segment is triangle in shape in which the height of the triangle is at least about 2 times the length of either or both of two sides of the triangle; for example, a triangular barrier material segment may be about 8 feet in height, about 3.9 feet on a first side and about 4 feet on a second side with the dimension of the third side being determined by the desired shape of the triangle, e.g., a right angle, equilateral, isosceles or scalene triangle.

In certain embodiments of the invention, the protective barrier material comprises one or more linkable barrier material segments, wherein at least one segment is a rhomboid shape (e.g., a shape with four sides where only the opposite sides and angles are equal). In particular embodiments, the barrier material segment is a rhomboid shape, in which the upper and lower lengths of the rhombus are at least about 1.05, e.g., about 1.1, e.g., about 1.2, e.g., about 1.3, e.g., about 1.4, e.g., about 1.5, e.g., about 1.6, e.g., about 1.7, e.g., about 1.8, e.g., about 1.9, e.g., about 2 times the length of the lateral sides. In particular embodiments, the barrier material segment is a rhomboid shape, in which the lateral sides of the rhombus are at least about 1.05, e.g., about 1.1, e.g., about 1.2, e.g., about 1.3, e.g., about 1.4, e.g., about 1.5, e.g., about 1.6, e.g., about 1.7, e.g., about 1.8, e.g., about 1.9, e.g., about 2 times the length of the upper and lower lengths sides. In one specific embodiment, the barrier material segment is rhomboid in shape in which the height of the rhombus is at least about 2 times the upper and lower lengths of the rhombus; for example, the barrier material segment is about 8 feet in height and about 4 feet in width.

In certain embodiments of the invention, the protective barrier material of the invention is formed from various and differing lengths and/or various and differing heights of barrier material segments to create holes or spaces in the protective barrier material to allow for structures extending essentially perpendicular to or from the vegetation, e.g., branches of a tree, to extend through the assembled VPS.

In certain embodiments of the invention, the protective barrier material may further comprise a strap, rope, or threading material that runs horizontally along/through the material (e.g., top, bottom, and/or middle of the material) to add additional circumferential security around the vegetation. In a particular embodiment, this strap, rope, or threading material may also serve as the reversible closure mechanism.

In certain embodiments of the invention, the protective barrier material may further comprise grommets, e.g., reinforced grommets, suitable for securely locking the VPS to a fixed object or to itself. In particular embodiments, there are grommets positioned at the top and bottom, e.g., on the edge of each lateral side, to afford security of the top and bottom to a fixed object or to the opposite lateral side.

In certain embodiments of the invention, the protective barrier material further comprises one or more tear slits, e.g., horizontally or vertically positioned. Such slits may be torn in order to afford the ability of the material to be shaped around an object. In a specific embodiment, such tear slits are reversible, e.g., may be re-secured into original position by hook and loop closure (e.g., VELCRO®), a buckle, a tie, a snap, a zipper, a ratchet-type binding, tape, button, hook and eye, elastic material and the like, or any combination thereof. In an alternative specific embodiment, such tear slits comprise one or more v-shaped slits at the edge of the protective barrier material.

C. Closure Mechanism

The VPS of the present invention is secured in place around the vegetation by engaging a reversible closure mechanism that is securely and operationally associated with at least one layer of the protective barrier material. The reversible closure mechanism may be any mechanism capable of reversibly coupling one lateral side of the VPS to the other lateral side of the VPS in a secure yet reversible manner. The reversible closure mechanism may also link one barrier material segment to one or more different barrier segments to comprise the protective barrier material, e.g., via the reversible closure mechanism for the VPS or a distinct/separate (secondary) reversible closure mechanism.

The reversible closure mechanism may comprise a closure component on one barrier material segment that may reversibly couple, or mate with a corresponding closure component on the same or different barrier material segment in order to engage the closure mechanism. The reversible closure mechanism is easily reusable in nature, that is, it may be opened, disconnected, disengaged, unlatched, unbuttoned, unfastened, or unsecured as needed; and closed, connected, engaged, re-engaged, fastened, re-fastened, latched, buttoned or secured as needed, e.g., with ease and by hand (e.g., without the need to cut or otherwise damage the closure mechanism or VPS, or without the use of hand tools such as pliers, wire cutters, snippers, scissors, hammers, hand saws of any type, axes, razors, box knives and the like, or any combination thereof).

The reversible closure mechanism is securely attached to the protective barrier material of the VPS in any manner, at any suitable position or orientation that allows the reversible closure mechanism to function, e.g., perpendicular to a lateral edge, parallel to a lateral edge, or at any angle between parallel or perpendicular to a lateral edge. Suitable methods of attachment to securely associate the reversible closure mechanism to any portion of the protective barrier material include, but are not limited to, sewing, stapling, glue, welding (e.g., hot gas, infrared, laser or ultrasonic welding, heat sealing, heat fusing or any combination thereof), manufacture of the closure mechanism as an integral member of the protective barrier material, or any combination thereof. The reversible closure mechanism is positioned or juxtaposed such that the closure component on one barrier material segment mates with a corresponding closure component on the same or different barrier material segment in their customary manner; for example the hook component is positioned to align and connect with the loop component in a hook and loop type closure mechanism. In particular embodiments, the closure mechanism is located at the top and bottom of the lateral edges of the protective barrier material.

In certain embodiments of the invention, the reversible closure mechanism may be hook and loop type (e.g., VELCRO®), a buckle, a tie, a snap, a zipper, a ratchet-type binding, tape, button, hook and eye, elastic material and the like, or any combination thereof. In certain embodiments, the reversible closure mechanism is hook and loop type, e.g., strips (e.g., VELCRO®), a tie, or a ratchet-type binding. In a particular embodiment, the reversible closure mechanism is hook and loop type strips (e.g., VELCRO®). In a particular embodiment, the reversible closure mechanism is a tie, for example, a strap that may be of varying length: to tie to the VPS to a fixed object, to a matching tie on the opposite lateral side of the VPS, and/or wrap around the entire VPS, e.g., before tying to a fixed object or the opposite lateral side.

In certain embodiments of the invention, the reversible closure mechanism is adjustable. For example, the reversible closure mechanism allows for easy and rapid adjustment, e.g., of the protective barrier material while in position around vegetation, e.g., in need of protection.

In certain embodiments, the reversible closure mechanism of the VPS allows for easy and rapid removal of the VPS in a condition suitable for immediate or near immediate use on other or the same vegetation. The removed VPS may be used again or stored, in a rolled, folded or flat condition, until the next use. In one embodiment, the VSS is removed, e.g., the struts are removed from the pockets or sleeves, while in another embodiment the VSS, e.g., the struts, remains, e.g., inside the pockets or sleeves of the VPS.

The reversible closure mechanism may be positioned with matching closure components positioned on the same face of the protective barrier material or on opposing faces.

In certain embodiments, the reversible closure mechanism may comprise two or more closure mechanisms, which when combined serve as the reversible closure mechanism of the VPS, e.g., when hook and loop type fasteners are used it may be broken up in smaller strips rather than one single strip. Such closure mechanisms may be distributed evenly or unevenly across the length and/or along the height of the protective barrier material.

In certain embodiments, the reversible closure mechanism is oriented along the lateral edges of the protective barrier material in vertical orientation. For example, in a particular embodiment, a first component VELCRO® strip comprising the “hook” side of the VELCRO® product is secured along one lateral edge and on one face of at least one layer of the protective barrier material along the height of the VPS, and a second component VELCRO® strip comprising the “loop” side of the VELCRO® product is secured along the opposing lateral edge and on the opposite face along the height of at least one layer of the protective barrier material. In a particular embodiment, a first component VELCRO® strip comprising the “hook” side of the VELCRO® product is secured along both faces of the protective barrier material along the height of one lateral edge of the protective barrier material, and a second component VELCRO® strip comprising the “loop” side of the VELCRO® product is secured along both faces of the opposing lateral edge along the height of the protective barrier material. In another particular embodiment, two first component VELCRO® strips comprising the “hook” side of the VELCRO® product are secured along one lateral edge and on each face of the protective barrier material along the height of the VPS and two second component VELCRO® strips comprising the “loop” side of the VELCRO® product are secured along the opposing lateral edge and on each face of the protective barrier material along the height of the protective barrier material.

In a particular embodiment of the invention, the reversible closure mechanism is a matching set of component strips of hook and loop type fasteners, e.g., VELCRO®, in which a strip corresponding to greater than about 90%, e.g., about 95%, e.g., about 100% of the height of the protective barrier material is securely associated with the protective barrier material on each lateral end of the protective barrier material, essentially in parallel with the VSS. In certain embodiments, the strips, e.g., of VELCRO®, are at least about 4, e.g., about 5, e.g., about 6, e.g., about 7, e.g., about 8, e.g., about 9, e.g., about 10 inches in width. In one particular embodiment, the strips, e.g., of VELCRO®, are about 6 inches in width.

In certain embodiments, the reversible closure mechanism is oriented perpendicular to the lateral edges of the protective barrier material in horizontal orientation. In a particular embodiment of the invention, the reversible closure mechanism is a matching set of component strips of hook and loop type fasteners, e.g., VELCRO®, in which a strip corresponding to greater than about 90%, e.g., about 95%, e.g., about 100% of the length of the protective barrier material is securely associated with the protective barrier material on each of the upper and lower ends of the protective barrier material, essentially perpendicular with the VSS. In certain embodiments, the strips, e.g., of VELCRO®, are at least about 4, e.g., about 5, e.g., about 6, e.g., about 7, e.g., about 8, e.g., about 9, e.g., about 10 inches in width. In one particular embodiment, the strips, e.g., of VELCRO®, are about 6 inches in width.

In certain embodiments, the reversible closure mechanism is oriented perpendicular to the lateral edges of the protective barrier material in horizontal orientation. In a particular embodiment of the invention, the reversible closure mechanism is a matching set of component strips of hook and loop type fasteners, e.g., VELCRO®, wherein each of the horizontal strips comprises at least two component strips that are a matching set such that the horizontal strip may serve as its own reversible closure mechanism for the VPS when reversibly connected to itself.

In certain embodiments, the reversible closure mechanism may be designed to provide overlap of one lateral edge of the protective barrier material with the other lateral edge, e.g., the protective barrier material encircles the vegetation and overlaps upon itself. In a particular embodiment, the protective barrier material encircles the vegetation with up to about 5 feet of overlap. In a particular embodiment, the protective barrier material encircles the vegetation with up to about 3 feet of overlap. In a particular embodiment, the protective barrier material encircles the vegetation with up to about 1 foot of overlap. In a particular embodiment, the protective barrier material encircles the vegetation with about 6 inches of overlap.

In one embodiment of the invention, a first component VELCRO® strip comprising the “hook” side of the VELCRO® product is secured along one lateral edge and on one face of the protective barrier material along the height of the VPS, and a second component VELCRO® strip comprising the “loop” side of the VELCRO® product is secured along the two horizontal edges (perpendicular to the lateral edges) and on the opposite face of the protective barrier material; affording an adjustable protective barrier material that can be adjusted to any length.

### III. PREFABRICATED VEGETATION PROTECTION BARRIER ASSEMBLY (PVPA) OF THE INVENTION

In another embodiment, the present invention relates to a prefabricated vegetation protection barrier assembly (PVPA) and methods of using the PVPA in protecting vegetation, including but not limited to plants, shrubs, bushes, saplings, trees and tree trunks. In certain embodiments, the prefabricated vegetation protection assembly (PVPA) of the invention is used to protect a tree, e.g., the trunk of a tree.

Accordingly, in one embodiment, the present invention provides a prefabricated vegetation protection barrier assembly (PVPA). The PVPA comprises a protective barrier material operationally associated with a vertical support scaffold (VSS), wherein the protective barrier material is securely associated with a reversible closure mechanism suitable for reversibly connecting one lateral end of the protective barrier material to the other lateral end of the protective barrier material, and wherein the protective barrier material comprises one or more linkable barrier material segments, and which provides a protective barrier for vegetation upon engaging the closure mechanism after vertically encircling the vegetation with the protective barrier material. Such PVPA are suitable for protecting vegetation from machinery, tools and other hazards at construction sites. Moreover, the vegetation protection systems of the present invention are engineered to be readily-reusable.

In certain embodiments, the present invention provides the vegetation protection systems of the present invention as a prefabricated unit or device. As such, in a particular embodiment, the prefabricated vegetation protection barrier assembly (PVPA) is assembled from the vegetation protection systems of the invention described herein, e.g., including the vertical support scaffold, the protective barrier material, and the reversible closure mechanism.

In certain embodiments of the PVPA, the protective barrier material comprises one or more linkable barrier material segments, which may be linked to each other in one or more locations, e.g., through a secondary reversible closure mechanism. In a particular embodiment, the protective barrier material comprises one barrier material segment. The single barrier material segment is sufficient to provide a protective barrier for vegetation, e.g., in need of protection, upon engaging the reversible closure mechanism after vertically encircling the vegetation with the single barrier segment. In certain embodiments, the secondary reversible closure mechanism is the same mechanism as the reversible closure mechanism of the VPS.

The protective barrier material of the PVPA, comprising a single or combination of multiple barrier material segments, may be any shape that can completely encircle the vegetation in need of protection. Thus, the protective barrier material may be rectangular, square, trapezoidal, triangular, rhomboid, or any other shape that allows the VPS to fully encircle the vegetation at the widest circumference.

In certain embodiments of the PVPA, the protective barrier material is between about 4 to about 10 feet in height and between about 2 to about 20 feet in lateral length.

In certain embodiments of the PVPA, the protective barrier material is about 4 feet in length and about 8 feet in height;

In one embodiment, the protective barrier material of PVPA is configured to receive 1 to 40 struts, e.g., 2 to 30 struts, e.g., 2 to 20 struts, e.g., 4 to 15 struts, e.g., 6 to 10 struts. In certain embodiments, the protective barrier material is configured such that the struts are not placed closer than about 6 inches to each end of the protective barrier material when operationally associated. In certain embodiments, the protective barrier material is configured such that the struts are evenly spaced along the length protective barrier material, e.g., spaced about 3 inches apart from center to center. In a particular embodiment, the structures are held in place in pockets or sleeves formed by stitching running from the top to the bottom, evenly spaced between the struts. In a specific embodiment, the struts, e.g., 1.5 inch diameter PVC pipe, are contained in a 2-layer protective barrier material, e.g., placed about 3 inches apart on center. In certain embodiments, the protective barrier material is 18 inches in length and comprises 5 struts. In certain embodiments, the protective barrier material is 24 inches in length and comprises 7 struts. In certain embodiments, the protective barrier material is 36 inches in length and comprises 10 struts. In certain embodiments, the protective barrier material is 4.25 feet in length and comprises 13 struts.

In certain embodiments, the vertical support scaffold comprises at least one strut, e.g., positioned at any location along the length of the protective barrier material (such as in the center of the protective barrier material or at either or both ends of the protective barrier material). In certain embodiments of the PVPA, the VSS comprises struts that are 1.5 inch diameter PVC plastic pipes about 8 feet in length evenly spaced across the length of the protective barrier material, wherein the struts are spaced about 3 inches apart from center to center; and the reversible closure mechanism comprises hook and loop-type strips, e.g., VELCRO®.

The reversible closure mechanism of the PVPA is securely attached to the protective barrier material of the PVPA in any manner, at any suitable position or orientation that allows the reversible closure mechanism to function, e.g., perpendicular to a lateral edge, parallel to a lateral edge, or at any angle between parallel or perpendicular to a lateral edge. Suitable methods of attachment to securely associate the reversible closure mechanism to any portion of the protective barrier material include, but are not limited to, sewing, stapling, glue, welding (e.g., hot gas, infrared, laser or ultrasonic welding, heat sealing, heat fusing or any combination thereof), manufacture of the closure mechanism as an integral member of the protective barrier material, or any combination thereof. The reversible closure mechanism is positioned or juxtaposed such that the closure component on one barrier material segment mates with a corresponding closure component on the same or different barrier material segment in their customary manner; for example the hook component is positioned to align and connect with the loop component in a hook and loop type closure mechanism.

In certain embodiments of the PVPA, the reversible closure mechanism may be hook and loop type (e.g., VELCRO®), a buckle, a tie, a snap, a zipper, a ratchet-type binding, tape, button, hook and eye, elastic material and the like, or any combination thereof. In certain embodiments, the reversible closure mechanism is hook and loop type, e.g., strips (e.g., VELCRO®) a tie, or a ratchet-type binding. In a particular embodiment, the reversible closure mechanism is hook and loop type strips (e.g., VELCRO®). In a particular embodiment, the reversible closure mechanism is a tie, for example, a strap that may be of varying length: to tie to the PVPA to a fixed object, to a matching tie on the opposite lateral side of the PVPA, and/or wrap around the entire PVPA, e.g., before tying to a fixed object or the opposite lateral side.

In one embodiment, additional various linkable protective barrier segments suitable for use with the assembled PVPA are provided with or as an additional kit.

### IV. THE TOOL-FREE METHOD FOR PROTECTING VEGETATION

The systems of the present invention afford a user a method of protecting vegetation that may be accomplished without the use of tools. In particular, the obtaining of PVPA of the present invention, followed by the encircling of vegetation, and the securing of the PVPA by engaging the reversible closure mechanism allows for the convenient protection of that vegetation without the need for any tools

As such, in another embodiment, the present invention provides a tool-free method for protecting vegetation, e.g., in need of protection, comprising the steps of obtaining a prefabricated vegetation protection barrier assembly (PVPA) of the invention, e.g., of a suitable height and length to encircle said vegetation; encircling the vegetation with the PVPA; and securing the VPS or PVPA around the vegetation by engaging the reversible closure mechanism. In certain embodiments, the vegetation in need of protection is a tree, e.g., the trunk of a tree.

In certain embodiments, the step of obtaining a prefabricated vegetation protection barrier assembly (PVPA) comprises assembly of a VPS of the present invention.

The reversible closure mechanism of the VPS or PVPA of the invention allows for easy and rapid adjustment of the VPS while it is in place around vegetation. For example, the VELCRO®, buckle, tie, snap, zipper, ratchet-type binding, tape, button hook and eye, elastic material and the like may be easily disengaged, e.g., without the use of hand tools, the length of the VPS adjusted while in place around the vegetation, and the reversible closure mechanism then easily engaged e.g., without the use of hand tools, to adjust and re-secure the VPS or PVPA around the vegetation.

In one embodiment, the reversible closure mechanism of the VPS allows for easy removal of the VPS or PVPA without the use of tools, in a condition suitable for immediate or near immediate use on other or the same vegetation. For example, the VELCRO®, buckle, tie, snap, zipper, ratchet-type binding, tape, button, hook and eye, elastic material, and the like may be easily disengaged, e.g., without the use of hand tools, and the VPS or PVPA removed from the vegetation. The removed VPS or PVPA may be used again or stored, in a rolled, folded or flat condition, until the next use. In certain embodiments, the VSS is removed from the PVPA, e.g., the struts are removed (e.g., from the pockets or sleeves) prior to storage. In an alternative embodiment, the VSS is retained in the PVPA during storage, e.g., the struts remain inside the pockets or sleeves during storage.

### Exemplification

Having thus described the invention in general terms, reference will now be made to the accompanying drawings of exemplary embodiments, which are not necessarily drawn to scale, and which are not intended to be limiting in any way.

In this respect, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

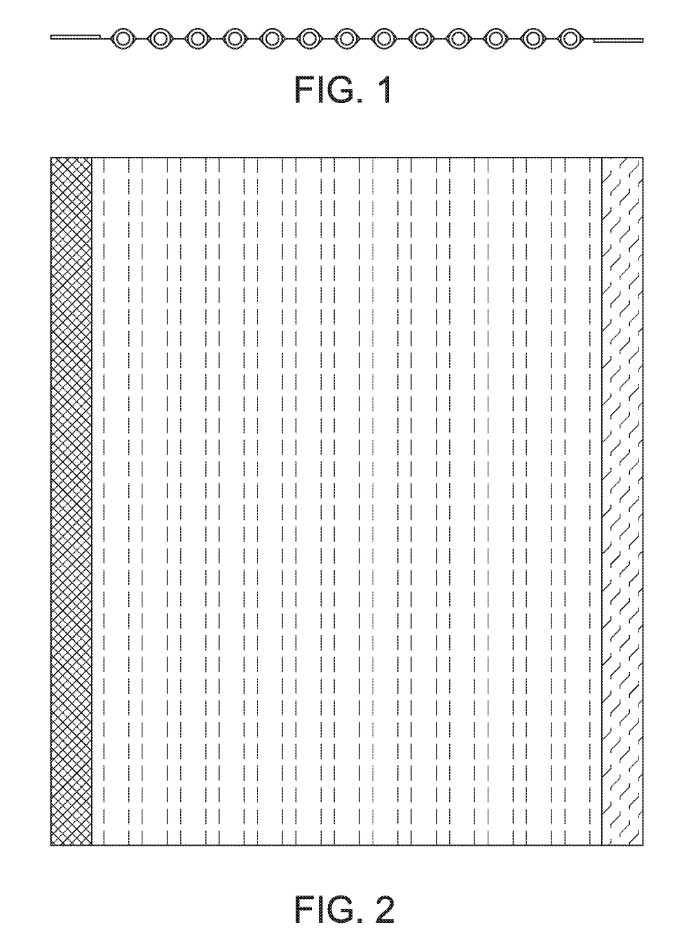

FIG. 1, a top down plan view perspective of certain particular embodiments of a prefabricated vegetation protection barrier assembly (PVPA) of the invention. This embodiment depicts the VSS as 13 evenly spaced struts comprising 1.5-inch PVC pipe in the cloth protective barrier material, which is stitched closed on all outside edges of two sheets of cloth, and wherein the stitching is used to bind the piping in between the two layers through the inclusion of a stitch run in between each PVC pipe in a linear manner, creating a sleeve arrangement. The reversible closure mechanism is hook and look Velcro®, which is stitched at the lateral edges to the protective barrier material.

Although this figure indicates, from a top down perspective, that the struts are centrally positioned, they may also be positioned on one side of the center axis, i.e., the struts may be positioned as jutting outward from one exterior layer side.

FIG. 2, an elevation view perspective of the particular embodiment depicted in FIG. 1 of a prefabricated vegetation protection barrier assembly (PVPA) of the invention, wherein the reversible closure mechanism is more easily discernable. Moreover, it is evident that the VSS in this embodiment does not extend beyond the protective barrier material.

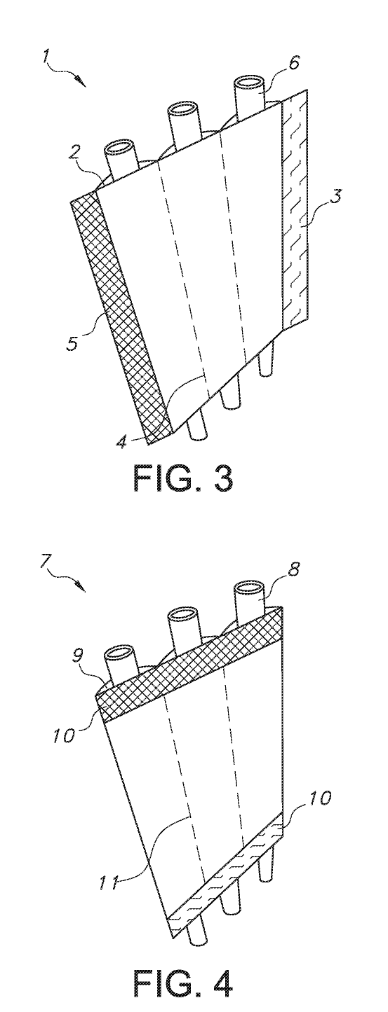

FIG. 3 depicts a sketched example of a particular embodiment of a PVPA 1 of the present invention. Trapezoidal protective barrier material comprises stitch runs 4 that create sleeves 2 with two openings, in which struts 6 may be inserted or removed, and which struts 6 extend beyond the height of the protective barrier. The reversible closure mechanism comprises hook and loop closure components 5 and 3 that may be reversibly coupled by connection to each other after encircling vegetation.

FIG. 4 depicts a sketched example of a particular embodiment of a barrier material segment 7 of the present invention. Trapezoidal protective barrier material comprises stitch runs 11 that create sleeves 9 with two openings, in which struts 8 may be inserted or removed, and which struts 8 extend beyond the height of the protective barrier. The reversible closure mechanism comprises hook and loop closure components 10 that may be reversibly coupled to other barrier material segments vertically or laterally by alternating the tops and bottoms so that the closure components form appropriate matched pairs suitable for reversible closure. In this embodiment the hook and loop closure components serve as both the manner of connecting additional barrier material segments and as the reversible closure mechanism of the PVPA/VPS.

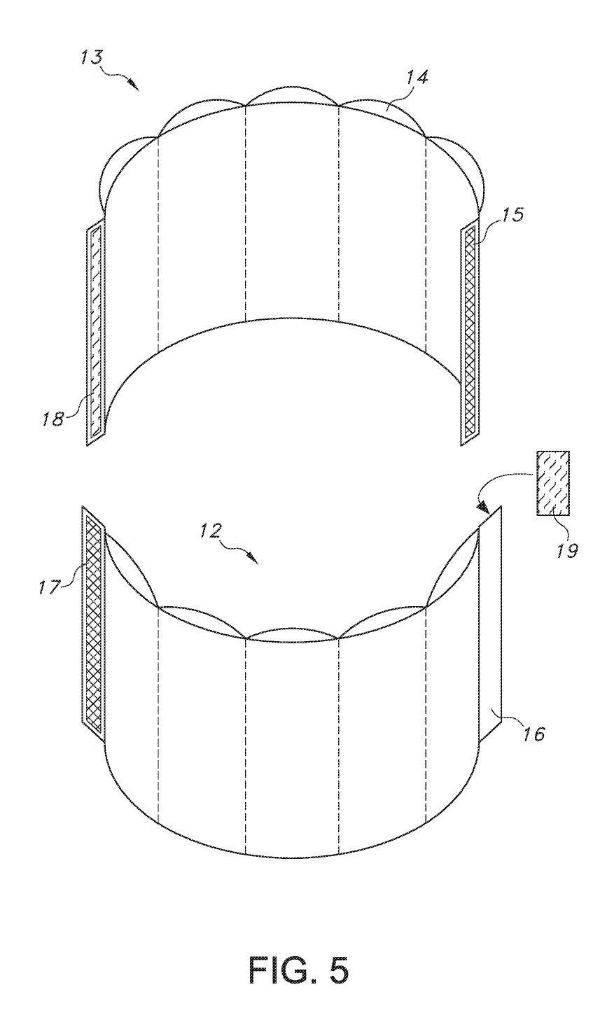

FIG. 5 depicts a sketched example of a particular embodiment of two barrier material segments of the present invention. Barrier material segments 12 and 13 are shown for easy visualization of alignment to encircle vegetation. The reversible closure mechanism of barrier material segment 12 (i.e., closure components 16 and 17) and 13 (i.e., closure components 15 and 18) may be utilized to reversibly couple closure components 17 and 18, and closure mechanism 16 and 15 (wherein the orientation of the fastening aspect of closure component 16 is shown in 19). The VSS, e.g., struts, does/do not extend beyond the rectangular protective barrier material, e.g., sleeve 14.

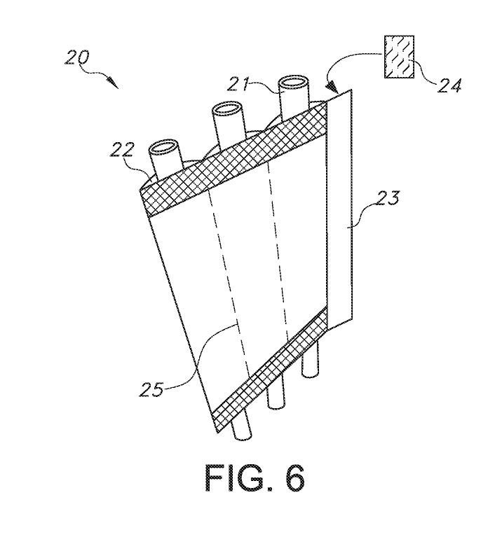

FIG. 6 depicts a sketched example of a particular embodiment of a PVPA 20 of the present invention. Trapezoidal protective barrier material comprises stitch runs 25 that create sleeves 22 with two openings, in which struts 21 may be inserted or removed, and which struts 21 extend beyond the height of the protective barrier. The reversible closure mechanism comprises hook and loop closure components along the upper and lower lengths that are designed to reversibly couple with the hook and loop component 23 upon encircling the vegetation, (wherein the orientation of the fastening aspect of closure component 23 is shown in 24).

### INCORPORATION BY REFERENCE

The entire contents of all patents, published patent applications and other references cited herein are hereby expressly incorporated herein in their entireties by reference.

### EQUIVALENTS

Those skilled in the art will recognize, or be able to ascertain using no more than routine experimentation, numerous equivalents to the specific procedures described herein. Such equivalents were considered to be within the scope of this invention and are covered by the following claims. Moreover, any numerical or alphabetical ranges provided herein are intended to include both the upper and lower value of those ranges. In addition, any listing or grouping is intended, at least in one embodiment, to represent a shorthand or convenient manner of listing independent embodiments; as such, each member of the list should be considered a separate embodiment.

What is claimed is:

1. A vegetation protection system (VPS), comprising a vertical support scaffold (VSS); and a protective barrier material capable of being operationally associated with the VSS, wherein the protective barrier material is securely associated with a reversible closure mechanism suitable for reversibly connecting one lateral end of the protective barrier material to the other lateral end of the protective barrier material, and
wherein the protective barrier material comprises one or more linkable barrier material segments, and which provides a protective barrier for vegetation upon engaging the closure mechanism after vertically encircling the vegetation with the protective barrier material.

2. The vegetation protection system (VPS) of claim 1, wherein the protective barrier material comprises one barrier material segment.

3. The vegetation protection system (VPS) of claim 1, wherein the protective barrier material comprises two or more linkable barrier material segments.

4. The vegetation protection system (VPS) of claim 3, wherein barrier material segments are linkable through a secondary reversible closure mechanism on the lateral edges of each barrier material segment.

5. The vegetation protection system (VPS) of claim, wherein the barrier material segments are rectangular, square, trapezoidal, triangular or rhomboid in shape.

6. The vegetation protection system (VPS) of claim 5, wherein the barrier material segments are rectangular in shape.

7. The vegetation protection system (VPS) of claim 1, wherein the vertical support scaffold (VSS) comprises two or more vertical struts.

8. The vegetation protection system (VPS) of claim 1, wherein the vertical support scaffold (VSS) comprises 1 to 40 struts.

9. The vegetation protection system (VPS) of claim 1, wherein each strut comprises a rigid material.

10. The vegetation protection system (VPS) of claim 9, wherein the rigid material is selected from the group consisting of wood, metal, plastic, and any combination thereof.

11. The vegetation protection system (VPS) of claim 10, wherein the plastic material is PVC.

12. The vegetation protection system (VPS) of claim 8, wherein the strut has a diameter of about 1 to 4 inches.

13. The vegetation protection system (VPS) of claim 1, wherein the protective barrier material comprises two exterior layers of material that are joined together.

14. The vegetation protection system (VPS) of claim 13, wherein the protective barrier material further comprising an internal layer within the area defined by the two exterior layers, wherein the internal layer is configured to receive the strut and retain the strut in substantially fixed position.

15. The vegetation protection system (VPS) of claim 1, wherein the protective barrier material is configured to allow insertion and removal of the struts from the protective barrier material.

15. The vegetation protection system (VPS) of claim 13, wherein the exterior layers comprise a material selected from the group consisting of cloth, plastic, and any combination thereof.

16. The vegetation protection system (VPS) of claim 1, wherein the reversible closure mechanism is adjustable.

17. The vegetation protection system (VPS) of claim 1, wherein the reversible closure mechanism is oriented along the lateral edges of the protective barrier material in vertical orientation.

18. The vegetation protection system (VPS) of claim 1, wherein the reversible closure mechanism is oriented perpendicular to the lateral edges of the protective barrier material in horizontal orientation.

19. The vegetation protection system (VPS) of claim 1, wherein the reversible closure mechanism is selected from the group consisting of a hook and loop fastener, a buckle, a tie, a snap, a zipper, a ratchet-type binding, tape, buttons, hook and eye, elastic material, or any compatible combination thereof.

20. The vegetation protection system (VPS) of claim 1, wherein the vegetation to be protected is a tree.

21. A prefabricated vegetation protection barrier assembly (PVPA), comprising a protective barrier material operationally associated with a vertical support scaffold (VSS), wherein the protective barrier material is securely associated with a reversible closure mechanism suitable for reversibly connecting one lateral end of the protective barrier material to the other lateral end of the protective barrier material, and
wherein the protective barrier material comprises one or more linkable barrier material segments, and which provides a protective barrier for vegetation upon engaging the closure mechanism after vertically encircling the vegetation with the protective barrier material.

22. The prefabricated vegetation protection barrier assembly (PVPA) of claim 21, wherein the protective barrier material is about 4 feet in length and about 8 feet in height;
the VSS comprises struts that are 1.5 inch diameter PVC plastic pipes about 8 feet in length evenly spaced across the length of the protective barrier material, wherein the struts are spaced about 3 inches apart from center to center; and
the reversible closure mechanism comprises hook and loop-type strips.

23. A tool-free method for protecting vegetation comprising the steps of:
obtaining a PVPA of claim 21 to encircle the vegetation in need of protection,
encircling the vegetation, and
securing said PVPA around the vegetation by engaging the reversible closure mechanism.
